(19) United States
(12) Patent Application Publication
(10) Pub. No.: US 2014/0195458 A1
(43) Pub. Date: Jul. 10, 2014

(54) METHODS, SYSTEMS, AND COMPUTER PROGRAM PRODUCTS FOR COMPILING EXPERIENCE RATINGS FOR SERVICE PROVIDERS

(71) Applicant: Pegmap, LLC., Wilmington, DE (US)

(72) Inventors: Edoardo Rizzi, Longmont, CO (US); Sameh Yamany, Longmont, CO (US)

(73) Assignee: Pegmap, LLC., Wilmington, DE (US)

(21) Appl. No.: 14/152,340

(22) Filed: Jan. 10, 2014

Related U.S. Application Data
(60) Provisional application No. 61/750,981, filed on Jan. 10, 2013.

(51) Int. Cl. G06Q 30/02; G06Q 50/30

(52) U.S. Cl. CPC G06Q 30/0282; G06Q 50/30
USPC 705/347

(57) ABSTRACT

A method for compiling experience ratings for service providers includes receiving a rating of a communication service provided by the service provider from a user of the communication service. The rating has a geographic location and a time associated therewith. The geographic map is updated with the rating that was received from the user.

### CROSS REFERENCE TO RELATED APPLICATION

This application claims the benefit of U.S. Provisional Application No. 61/750,981, filed Jan. 10, 2013, the disclosure of which is hereby incorporated herein by reference.

### FIELD OF THE INVENTION

The present invention relates to communication networks and methods of operating the same, and, more particularly, to methods, system, and computer program products for evaluating the performance of services provided over communication networks.

### BACKGROUND

Various rating organizations exist for providing quality ratings of telecommunication service providers. These ratings are often generated based on customer surveys filled out by users or experts in the field using the service(s) and evaluating the service(s) based on their experiences. The data that is used to generate these rankings, however, is usually not collected during or immediately after the service is used. Instead, the data is usually compiled from users voluntarily completing a survey by mail or online in response to a solicitation from a rating organization.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments provide a method for compiling experience ratings for service providers comprising receiving a rating of a communication service provided by the service provider from a user of the communication service. The rating has a geographic location and a time associated therewith. The geographic map is updated with the rating that was received from the user.

In other embodiments, the service provider is a first service provider and the method further comprises receiving ratings of the communication service provided by the first service provider and provided by a second service provider from a plurality of users and providing the user with the geographic map that displays the ratings received for the communication service provided by the first and second service providers in an area proximate to the geographic location.

In still other embodiments, the method further comprises performing a speed test on the communication link over which the communication service is provided while the user was generating the rating of the communication service and communicating a result of the speed test to the user.

In still other embodiments, the rating was generated by the user while using the communication service.

In still other embodiments, the rating is an ordinal level rating.

In still other embodiments, the rating has an activity associated therewith.

In still other embodiments, the rating has user comments associated therewith.

In still other embodiments, the geographic map is a first geographic map and the method further comprises receiving an identification of a second geographic location from the user, receiving an identification of a communication service, and providing the user with a second geographic map that displays ratings received for the communication service that was identified from a plurality of users proximate to the second geographic location.

In still other embodiments, receiving the rating of the communication service comprises receiving a plurality of ratings of the communication service provided by the service provider from a plurality of users of the communication service, the ratings having the geographic location and a plurality of times associated therewith, respectively and communicating the ratings to the service provider without disclosing identities of the plurality of users.

Although described primarily above with respect to method embodiments of the present inventive subject matter, it will be understood that the present invention may be embodied as methods, systems, and/or computer program products.

Other methods, systems, articles of manufacture, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram of a communication network that includes a communication service rating capability according to some embodiments of the inventive subject matter;

FIG. 2 is a block diagram that illustrates a software/hardware architecture for a user device for rating a communication service provided by a service provider according to some embodiments of the inventive subject matter;

FIG. 3 is a block diagram that illustrates a software/hardware architecture for a communication service ratings server according to some embodiments of the inventive subject matter;

FIG. 4 is a flowchart that illustrates operations for rating a communication service according to some embodiments of the inventive subject matter; and

FIGS. 5-11 are user interface screen shots from a user device for rating a communication service according to some embodiments of the inventive subject matter.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments may be embodied as methods, systems, and/or computer program products. Accordingly, exemplary embodiments may be embodied in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory,

As used herein, the term “mobile device” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile devices may also be referred to as “pervasive computing” devices.

Some embodiments described herein stem from a realization that improvements in communication services, such as high-speed broadband services and the like, may be encouraged through timely, unbiased feedback from users of those services. In some embodiments, users may install an application, which may be called a PegMap application, on their device(s) used to access communication services. When using a service, a user may provide feedback on the quality of the service through the PegMap application including a geographic location and time that the service was used, which is uploaded to a PegMap server in the cloud, for example. The PegMap server may compile these ratings for a particular service and may provide them to the service provides without attribution of the individual users so as to preserve their privacy. The service provider may then review the rating information from the users to obtain a neutral evaluation of the quality of the service being provided. The user rating information may have a geographic location and/or time associated therewith so that transitory problems can be readily identified along problems that may be associated with particular geographic locations.

In addition to encouraging service providers to improve the quality of their services based on user feedback, users may also benefit through the ability to communicate with the PegMap server to check on how certain services and/or service providers are rated in a particular geographic area. The user may filter the information to show ratings for all service providers or a particular service provider or providers. The user may also filter the information to show ratings based on the particular activity involved, including, but not limited to, voice calls, data/video streaming, Web browsing, email, using social media, and the like.

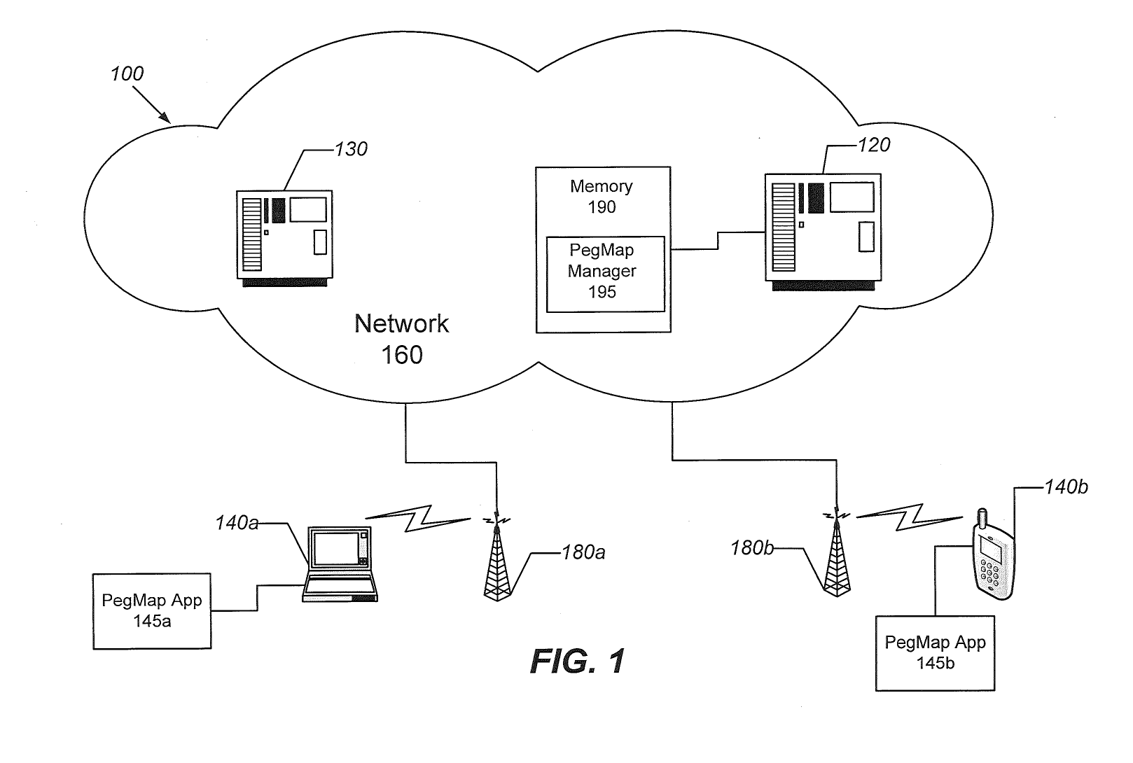

Referring now to FIG. 1, a communication network 100 includes a PegMap server 120 and a server 130 that is operated by a service provider to provide a communications service to one or more mobile devices 140a and 140b. In particular, as shown in FIG. 1, the mobile devices 140a and 140b communicate with the enterprise server 130 over a network 160. The network 160 may represent a global network, such as the Internet, or other publicly accessible network. Furthermore, the network 160 may represent a combination of public and private networks, such as a wide area network, local area network, Intranet, virtual private network (VPN), and/or other private network. The network 160 includes wireless base station transceivers 180a and 180b that may facilitate wireless communication with the mobile devices 140a and 140b. Although only two mobile devices 140a and 140b are shown, it will be understood that the network 160 may support large numbers of mobile devices and wireline devices according to some embodiments of the inventive subject matter. Moreover, although only a single service provider server 130 is shown, it will be understood that multiple services may be provided to users of mobile and/or wireline devices through a variety of different servers operated by one or more service providers according to some embodiments of the inventive subject matter.

The PegMap server 120 is equipped with a memory 190 that is representative of the one or more memory devices containing the software and data used to collect and compile user experience ratings for services provided by one or more service providers. The memory 190 may include, but is not limited to, the following types of devices: cache, ROM, PROM, EPROM, EEPROM, flash, SRAM, and DRAM. As shown in FIG. 1, the memory 190 may contain a PegMap module 195 that is configured to collect ratings of communication services provided through one or more service providers from users of the services through their mobile devices 140a and 140b, for example. The PegMap manager 195 may also provide an interface through which users can view the compiled ratings of various services, activities, and service providers based on a particular geographic area, for example. The PegMap manager 195 may provide the collected communication service ratings to the various service provider(s) without attribution to the actual users that provided the ratings to preserve their confidentiality. The service provider(s) may then use the unbiased feedback from their users/customers to improve their service and better understand weaknesses or faults in their service delivery systems and software.

It will be appreciated that in accordance with various embodiments of the inventive subject matter, the PegMap server 120 may be implemented as a single server, separate servers, or a network of servers either co-located in a server farm, for example, or located in different geographic regions.

Each user device, such as user devices 140a and 140b is equipped with a PegMap client application 145a, 145b that provides an interface for the user to rate service(s) and upload the rating information to the PegMap server 120. The PegMap application 145a, 145b may also allow the user to communicate with the PegMap server 120 to download service rating information for specific geographic areas, service providers, service types, and/or activity types using a variety of selection filters.

Although FIG. 1 illustrates an exemplary communication network and an exemplary hardware/software architecture that may be used in a data processing system, such as the PegMap server 120 and user devices 140a, 140b, for collecting ratings of communication services from users of the services through their access devices, it will be understood that embodiments of the present invention are not limited to such a configuration but are intended to encompass any configuration capable of carrying out operations described herein.

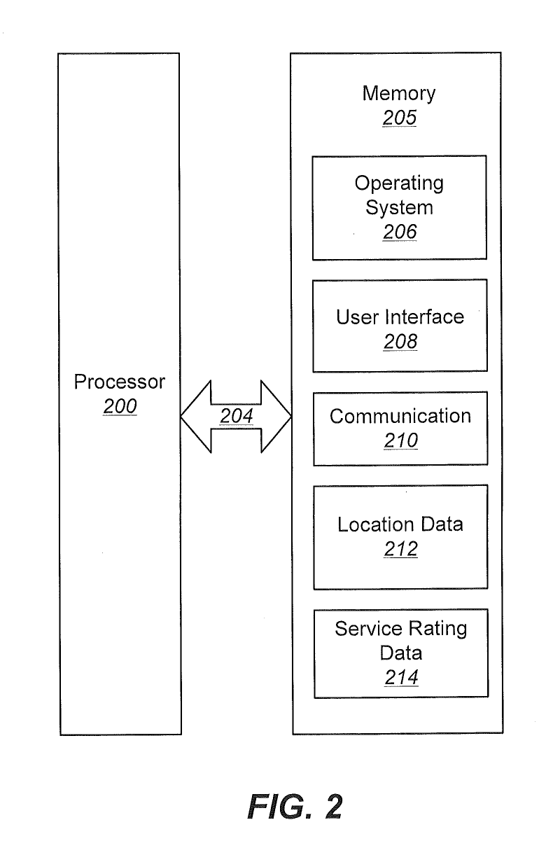

FIG. 2 is a block diagram that illustrates a processor 200 and memory 205 that may be used in embodiments of a user device for rating a communication service provided by a service provider according to some embodiments of the inventive subject matter. The processor 200 communicates with the memory 205 via an address/data bus 204. The processor 200 may be, for example, a commercially available or custom microprocessor. The memory 205 is representative of the one or more memory devices containing the software and data used to rate communication services in accordance with some embodiments of the inventive subject matter. The memory 205 may include, but is not limited to, the following types of devices: cache, ROM, PROM, EPROM, EEPROM, flash, SRAM, and DRAM.

As shown in FIG. 2, the memory 205 may contain five or more categories of software and/or data: an operating system 206, a user interface module 208, a communication module 210, a location data module 212, and a service rating data module 214. The operating system 206 generally controls the operation of the data processing system. In particular, the operating system 206 may manage the data processing system's software and/or hardware resources and may coordinate execution of programs by the processor 200.

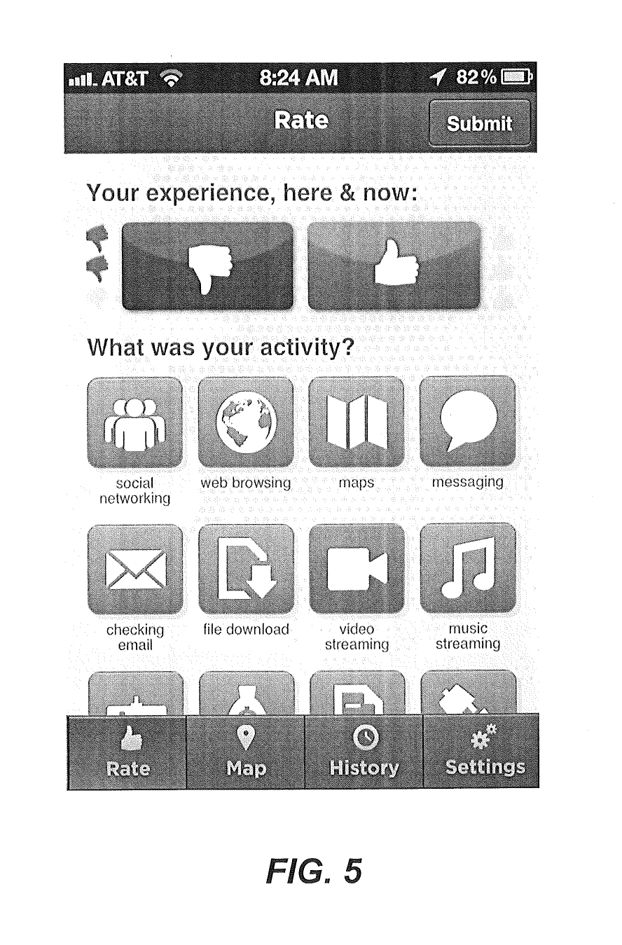

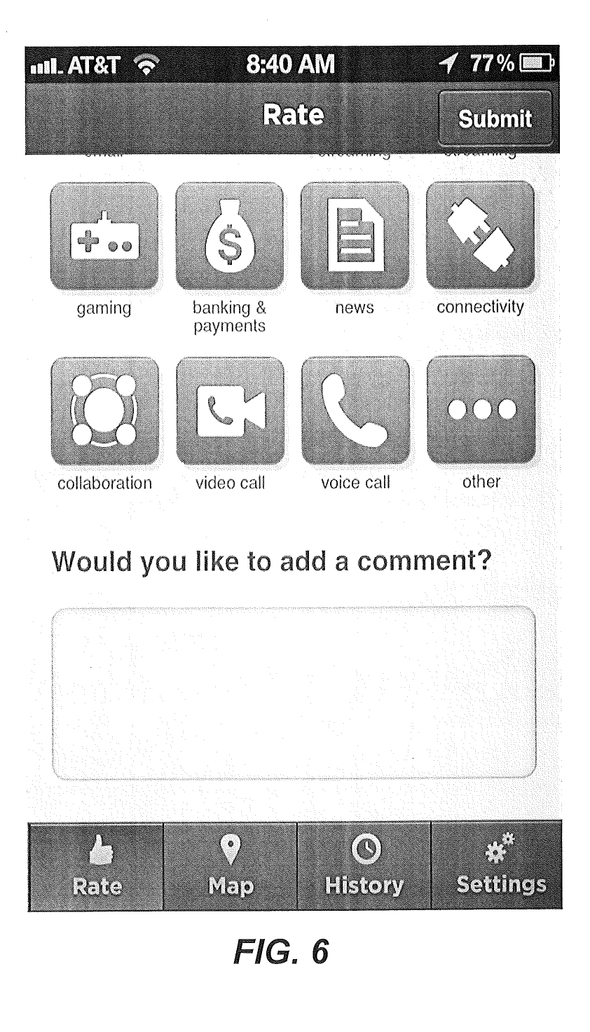

The user interface module 208 may be configured to provide an interface for the user to rate a particular service. FIGS. 5 and 6 illustrate the user interface executing on a mobile device according to some embodiments of the inventive subject matter. As shown in FIGS. 5 and 6, the user may rate a communication service via an ordinal level rating using one or more thumbs up or thumbs down indicators. The user may also identify what type of activity the user was/is engaged in as part of the rating. Activities may include, but are not limited to, social networking, Web browsing, map reading, messaging, email, file downloading, video streaming, music streaming, gaming, banking/payments, reading news, connectivity, collaboration, video call, and/or voice call. The user may also provide written comments as part of the rating providing further detail regarding the quality of the communication service.

The communication module 210 may be configured to upload communication service ratings to the PegMap server 120 and download information through, for example, a browser interface from the PegMap server 120. For example, a user device 140a, 140b may display a map of a geographic area showing communication service ratings collected by the PegMap server 120. This may allow the user to see if other users are experiencing similar difficulties and/or if there are other service providers that may provide higher rated service in a particular geographic area. The user may adjust the size of the geographic area within limits set by the PegMap server 120. The limits may be based on various factors including, but not limited to, boundaries within which certain service providers operate, governmental boundaries, population densities, and the like.

The location data module 212 may be configured to obtain geographic location data from the user device 140a, 140b to associate with the user rating. In some embodiments, the location data module 212 may obtain the geographic location data from a GPS unit or other navigation application that is part of the user device 140a, 140b. In other embodiments, the user may manually enter the geographic location that should be associated with a particular rating.

The service rating data module 314 contains the communication service rating data/information generated by the user through the user interface module 208 to be uploaded to the PegMap server 120.

Although FIG. 2 illustrates an exemplary hardware/software architecture that may be used in data processing systems, such as user devices 140a, 140b of FIG. 1, for implementing various functionality user devices 140a, 140b in accordance with some embodiments of the inventive subject matter, it will be understood that the present invention is not limited to such a configuration but is intended to encompass any configuration capable of carrying out operations described herein. Moreover, the functionality of the user devices 140a, 140b of FIG. 1 and the hardware/software architecture of FIG. 2 may be implemented as a single processor system, a multi-processor system, a multi-core processor system, or even a network of stand-alone computer systems, in accordance with various embodiments.

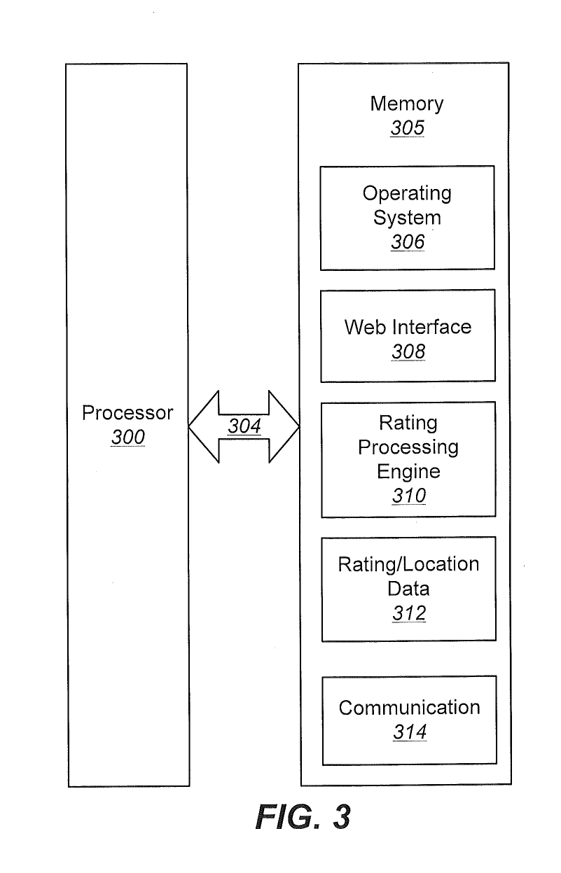

FIG. 3 is a block diagram that illustrates a processor 300 and memory 305 that may be used in embodiments of a PegMap server 120 for collecting and processing ratings for communication services provided by service providers according to some embodiments of the inventive subject matter. The processor 300 communicates with the memory 305 via an address/data bus 304. The processor 300 may be, for example, a commercially available or custom microprocessor. The memory 305 is representative of the one or more memory devices containing the software and data used to rate communication services in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain five or more categories of software and/or data: an operating system 306, a Web interface module 308, a rating processing engine module 310, rating/location data module 312, and a communication module 314. The operating system 306 generally controls the operation of the data processing system. In particular, the operating system 306 may manage the data processing system's software and/or hardware resources and may coordinate execution of programs by the processor 300.

The Web interface module 308 may be configured to provide users access to service rating information that has been compiled and processed from various users. As described above, the Web interface module 308 may provide in the form of a Web page or other suitable format, for example, a map of a geographic area showing communication service ratings collected by the PegMap server 120

The rating processing engine module 310 may be configured to collect and process communication service rating information from users for multiple services, activities, and/or service providers. The rating processing engine module 310 may compile and organize the service rating information according to service provider, activity, geographic area, written comments, and other parameters so that the information can be provided to users and/or service providers in a requested format.

The rating/location data module 312 may represent the communication service ratings received from users. The ratings may each include a geographic area and/or timestamp associated therewith as the relevance of a rating may be closely associated with a particular geographic area and/or time.

The communication module 314 may be configured to communicate service rating data/information to the various service providers whose services have been rated without attribution to the actual identities of the parties that provided the ratings so as not to discourage users from providing candid rating information. The communication module 314 may also facilitate communication with users of the services or other entities, such as social media sites, consumer advocacy organizations, and the like that may be desirous of publishing service rating information.

Although FIG. 3 illustrates an exemplary hardware/software architecture that may be used in a data processing system, such as the PegMap server 120 of FIG. 1 in accordance with some embodiments of the inventive subject matter, it will be understood that the present invention is not limited to such a configuration but is intended to encompass any configuration capable of carrying out operations described herein. Moreover, the functionality of the user devices of the PegMap server 120 of FIG. 1 and the hardware/software architecture of FIG. 3 may be implemented as a single processor system, a multi-processor system, a multi-core processor system, or even a network of stand-alone computer systems, in accordance with various embodiments.

Computer program code for carrying out operations of data processing systems and servers described above with respect to FIGS. 1-3, such as the MDM-IP 120, may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to flowchart and/or block diagram illustrations of methods, systems, and computer program products in accordance with exemplary embodiments. These flowchart and/or block diagrams further illustrate exemplary operations for compiling and processing user experience ratings for communication services received from users/customers in accordance with some embodiments of the inventive subject matter, It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks,

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

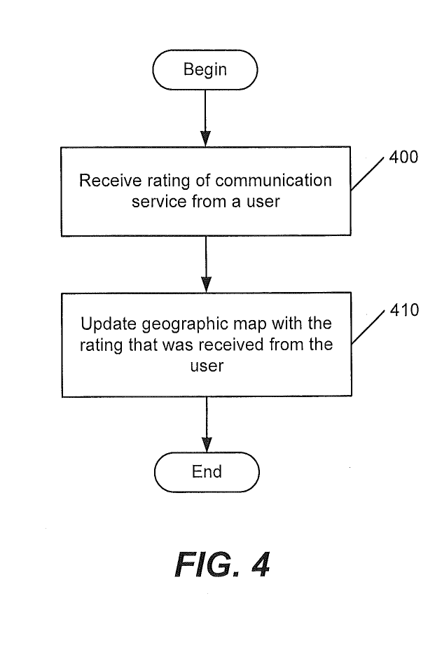

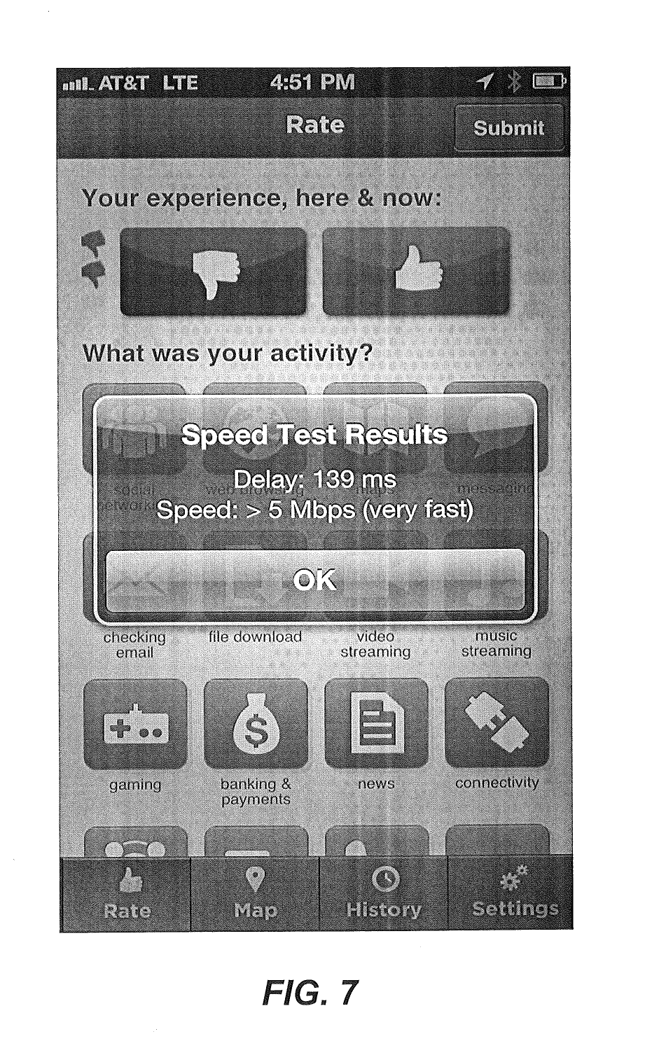

Referring now to FIG. 4, exemplary operations for compiling and processing user experience ratings for communication services received from users/customers begin at block 400 where the PegMap server 120 receives a communication service rating from one or more users/customers. As described above, the communication service rating may have a geographic location and/or a timestamp associated therewith that are communicated with the rating. This geographic location may be provided, for example, by a location component associated with a user device, such as a GPS unit, navigation unit, or the like. The communication service rating may be initiated by the user while the user is using the communication service or within a short time after the user has completed using the service. The PegMap server 120 may use the communication module 314 of FIG. 3 to perform a speed test result on the communication link over which the communication service is being provided while the user is ranking the communication service as shown in FIG. 7. As described above with respect to FIGS. 5 and 6, the user may provide an indication of the activity being performed along with written comments, which may accompany the rating and provide additional detail for the rating.

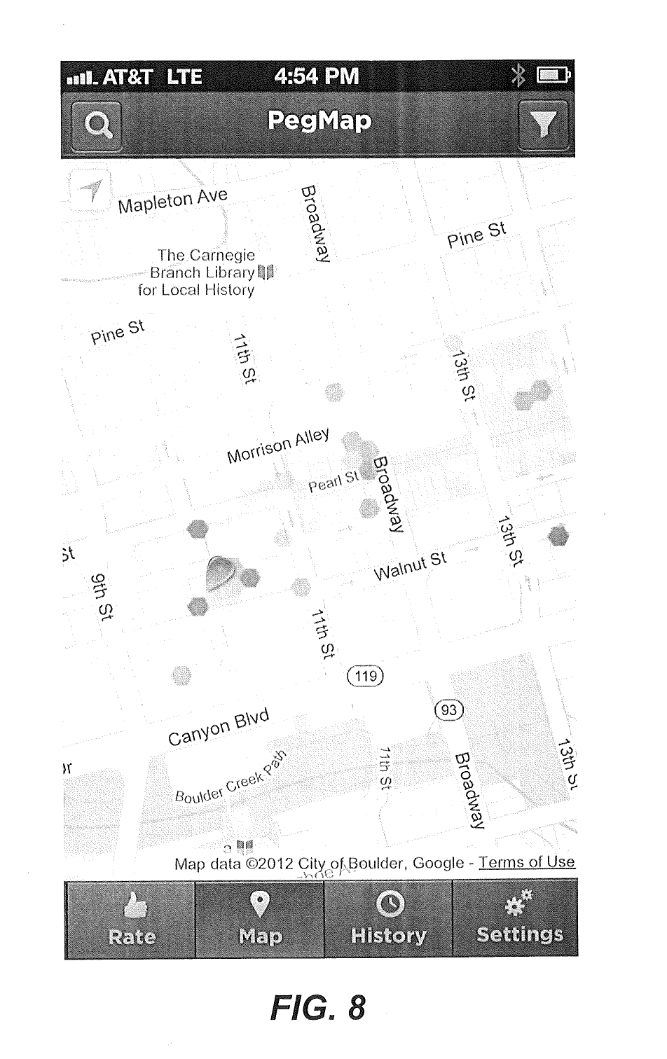

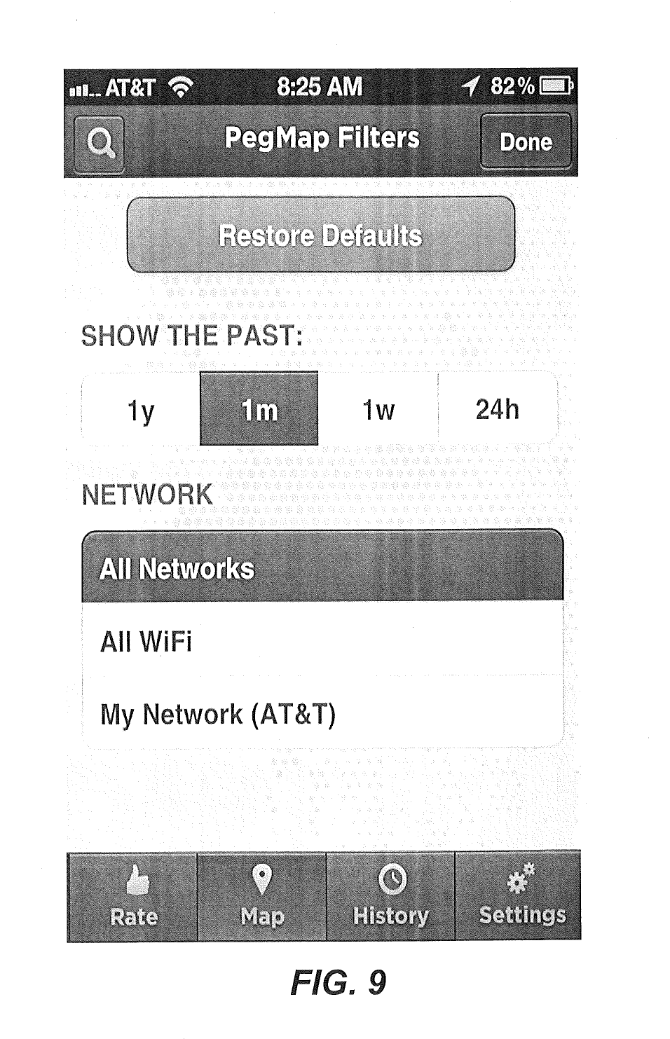

At block 410, the PegMap server 120 may update a geographic map with the one or more ratings received from one or more users/customers. FIG. 8 illustrates a geographic map showing ratings for one or more services provided by one or more service providers as spots thereon. The coloring of the spots on the map indicates the particular rating level in the example shown. The geographic map, such as the one shown in FIG. 8, for example, may be provided to the user upon request and/or automatically after the user submits a new rating. This may provide the user with an indication of whether others are experiencing similar service or if there are areas proximal to the user that may provide better service. The user may filter the geographic map so as to provide the type of information most relevant to the user. For example, the user may wish to filter the map as shown in FIG. 9 to only show ratings generated in the past year, month, week, or day. The user may also want to show ratings for all service providers, all WiFi, service providers, a particular service provider, or some other suitable type of filter. The user may also filter the ratings shown in the geographic map based on activity performed or desired parameter.

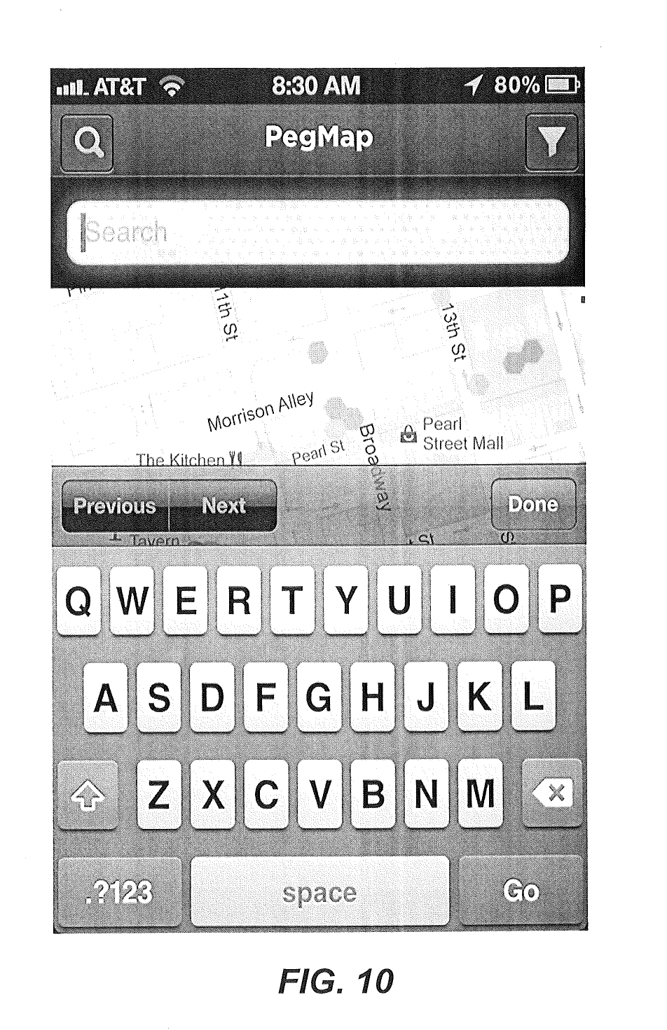

In other embodiments shown in FIG. 10, the user may enter in a particular geographic location by address via an interface provided between the communication module 210 and the Web interface 308 to allow the user view rating information that has been received from users at the PegMap server 120 for a particular area. This may allow a user to see if a particular service may be better in another part of the town or state, or see if a particular service provider receives high rankings in a broad geographic area, for example.

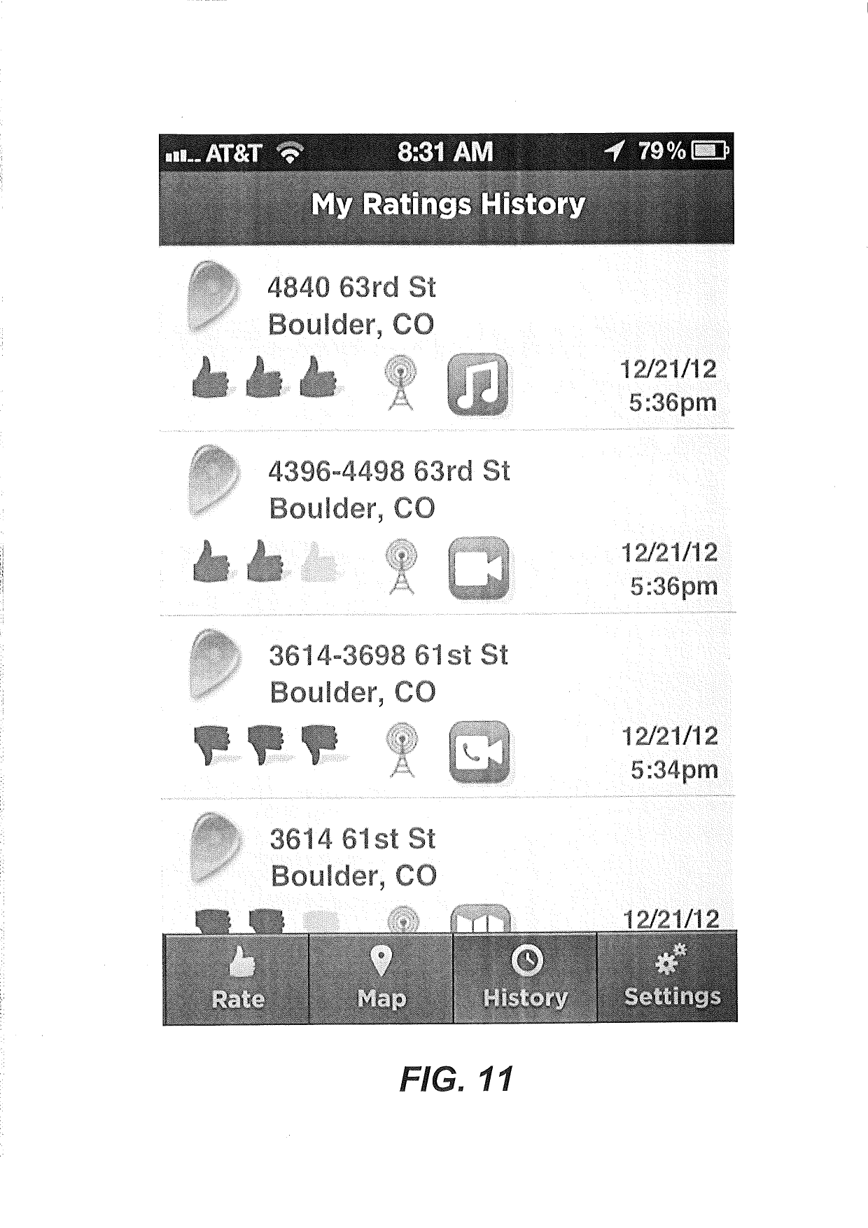

The various ratings submitted by a user may be stored locally on the user's device 140a, 140b or accessed from the PegMap server 120. FIG. 11 shows a listing of a user's recent communication service ratings with icons associated with the particular activity that was rated. In the example shown in FIG. 11, the user had rated a music service, a video streaming service, and a video call service. The user may wish to review the ratings history to determine, for example, which locations may be best to access a particular type of activity or service. In some embodiments, additional information such as landmarks, waypoints, and the like may be included with the geographic address information or used instead of the geographic address information for the user's convenience in identifying locations.

The flowchart of FIG. 4 illustrates the architecture, functionality, and operations of some embodiments of methods, systems, and computer program products for compiling and processing user experience ratings for communication services received from users/customers. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

According to some embodiments of the inventive subject matter described above, rating of communication services through the PegMap server 120 and PegMap applications 145a, 145b running on user devices may benefit both the users and the providers of broadband networks, services, and applications. Users may obtain the insight they need to make decisions that maximize or improve their experience as customers of service providers. Service providers may obtain visibility into the actual, unbiased satisfaction of their users and may also achieve an increased sense of urgency to address real problems with their networks, services, and/or applications.

Many variations and modifications can be made to the preferred embodiments without substantially departing from the principles of the present invention. All such variations and modifications are intended to be included herein within the scope of the present invention, as set forth in the following claims.

That which is claimed:

1. A method, comprising:
receiving a rating of a communication service provided by a service provider from a user of the communication service, the rating having a geographic location and a time associated therewith; and
updating a geographic map with the rating that was received from the user.

2. The method of claim 1, wherein the service provider is a first service provider, the method further comprising:
receiving ratings of the communication service provided by the first service provider and provided by a second service provider from a plurality of users; and
providing the user with the geographic map that displays the ratings received for the communication service provided by the first and second service providers in an area proximate to the geographic location.

3. The method of claim 1, further comprising:
performing a speed test on the communication link over which the communication service is provided while the user was generating the rating of the communication service; and
communicating a result of the speed test to the user.

4. The method of claim 1, wherein the rating was generated by the user while using the communication service.

5. The method of claim 1, wherein the rating is an ordinal level rating.

6. The method of claim 1, wherein the rating has an activity associated therewith.

7. The method of claim 1, wherein the rating has user comments associated therewith.

8. The method of claim 1, wherein the geographic map is a first geographic map, the method further comprising:
receiving an identification of a second geographic location from the user;
receiving an identification of a communication service; and
providing the user with a second geographic map that displays ratings received for the communication service that was identified from a plurality of users proximate to the second geographic location.

9. The method of claim 1, wherein receiving the rating of the communication service comprises:
receiving a plurality of ratings of the communication service provided by the service provider from a plurality of users of the communication service, the ratings having the geographic location and a plurality of times associated therewith, respectively; and
communicating the ratings to the service provider without disclosing identities of the plurality of users.

10. A system, comprising:
a processor; and
a memory coupled to the processor and comprising computer readable program code embodied in the memory that when executed by the processor causes the processor to perform operations comprising:
receiving a rating of a communication service provided by a service provider from a user of the communication service, the rating having a geographic location and a time associated therewith; and
updating a geographic map with the rating that was received from the user.

11. The system of claim 10, wherein the service provider is a first service provider, the operations further comprising:
receiving ratings of the communication service provided by the first service provider and provided by a second service provider from a plurality of users; and
providing the user with the geographic map that displays the ratings received for the communication service provided by the first and second service providers in an area proximate to the geographic location.

12. The system of claim 10, further comprising:
performing a speed test on the communication link over which the communication service is provided while the user was generating the rating of the communication service; and
communicating a result of the speed test to the user.

13. The system of claim 10, wherein the rating was generated by the user while using the communication service.

14. The system of claim 10, wherein the rating is an ordinal level rating.

15. The system of claim 10, wherein the rating has an activity associated therewith.

16. The system of claim 10, wherein the rating has user comments associated therewith.

17. The system of claim 10, wherein the geographic map is a first geographic map, the operations further comprising:
receiving an identification of a second geographic location from the user;
receiving an identification of a communication service; and
providing the user with a second geographic map that displays ratings received for the communication service that was identified from a plurality of users proximate to the second geographic location.

18. The system of claim 10, wherein receiving the rating of the communication service comprises:
receiving a plurality of ratings of the communication service provided by the service provider from a plurality of users of the communication service, the ratings having the geographic location and a plurality of times associated therewith, respectively; and
communicating the ratings to the service provider without disclosing identities of the plurality of users.

19. A computer program product, comprising:
a tangible computer readable storage medium comprising computer readable program code embodied in the medium that when executed by a processor causes the processor to perform operations comprising:
receiving a rating of a communication service provided by a service provider from a user of the communication service, the rating having a geographic location and a time associated therewith; and
updating a geographic map with the rating that was received from the user.

20. The computer program product of claim 19, wherein the service provider is a first service provider, the operations further comprising:
receiving ratings of the communication service provided by the first service provider and provided by a second service provider from a plurality of users; and
providing the user with the geographic map that displays the ratings received for the communication service provided by the first and second service providers in an area proximate to the geographic location.

21. The computer program product of claim 19, further comprising:
performing a speed test on the communication link over which the communication service is provided while the user was generating the rating of the communication service; and
communicating a result of the speed test to the user.

22. The computer program product of claim 19, wherein the rating was generated by the user while using the communication service.

23. The computer program product of claim 19, wherein the rating is an ordinal level rating.

24. The computer program product of claim 19, wherein the rating has an activity associated therewith.

25. The system of claim 19, wherein the rating has user comments associated therewith.

26. The computer program product of claim 19, wherein the geographic map is a first geographic map, the operations further comprising:
receiving an identification of a second geographic location from the user;
receiving an identification of a communication service; and
providing the user with a second geographic map that displays ratings received for the communication service that was identified from a plurality of users proximate to the second geographic location.

27. The computer program product of claim 19, wherein receiving the rating of the communication service comprises:
receiving a plurality of ratings of the communication service provided by the service provider from a plurality of users of the communication service, the ratings having the geographic location and a plurality of times associated therewith, respectively; and
communicating the ratings to the service provider without disclosing identities of the plurality of users.
